(19) United States
(12) Patent Application Publication
(10) Pub. No.: US 2008/0238266 A1
(43) Pub. Date: Oct. 2, 2008

(54) Axial gap type engine driven generator

(76) Inventors: Takashi Moriyama, Kobe-shi (JP); Hiromitsu Shimizu, Amagasaki-shi (JP)

Correspondence Address: JACOBSON HOLMAN PLLC, 400 SEVENTH STREET N.W., SUITE 600, WASHINGTON, DC, 20004, US

(21) Appl. No.: 11/798,625

(22) Filed: May 15, 2007

(30) Foreign Application Priority Data
Mar. 26, 2007 (JP) 2007-78721

(51) Int. Cl. H02K 7/00

(52) U.S. Cl. 310/67 R

(57) ABSTRACT

An axial gap type generator which is shorter in axial length and lightweight is provided. An axial gap type engine driven generator in an axial gap type generator formed by an armature and a field magnet disposed in a housing along an axial direction of a drive shaft 100 includes a coreless armature 110 which is fixedly supported in the housing and to which an armature coil is mounted, and a pair of rotating field magnets 120 which have a pair of rotary disks to which permanent magnets 122 are mounted respectively, and are mounted to a drive shaft to sandwich the armature from both sides in a thickness direction of the armature.

### BACKGROUND OF THE INVENTION

1. Field of the Invention

The present invention relates to a generator using a permanent magnet for a field magnet, and more particularly, to an axial gap type engine driven generator in which an armature and a field magnet are disposed in an axial direction of a drive shaft.

2. Related Art

In recent years, an engine driven generator using a permanent magnet for a field magnet has come into widespread use, and for example, the one disclosed in Japanese Patent No. 2679758 is provided. This generator uses a neodymium-iron-boron rare earth magnet for the field magnet and has an axial length substantially shorter than that of a former generator.

Since the generator disclosed in Japanese Patent No. 2679758 has a radial gap structure, the field magnet and the armature are arranged in the radial direction to form a magnetic gap between them. Therefore, the equipment dimension in the axial direction is required due to the arrangement of the field magnet and the armature for forming the magnetic gap, and the generator protrudes further from the drive shaft of the engine. The protruded length is significantly large.

This is a problem in the respect that it becomes difficult to meet the demand for compactness and high output of the generator. Thus, an axial gap type engine driven generator is required.

However, in order to construct a compact and lightweight axial gap type generator, various kinds of problems need to be solved. There are the basic problems: first, which one of an armature and a field magnet is made a stator side while the other one is made a movable side; next, how the armature and the field magnet are constructed; further, how the internal heat generation due to reduction in size is dissipated, and the like.

Cores (iron cores) are generally used for an armature and a field in the viewpoint of the magnetic efficiency, but use of cores increases the weight, and inhibits reduction in weight.

The present invention is made in consideration of the above described respects, and has an object to provide an axial gap type engine driven generator which is shorter in axial length and lightweight.

### SUMMARY OF THE INVENTION

In order to attain the above-described object, the present invention provides an axial gap type engine driven generator in an axial gap type generator that is an engine driven generator driven by an engine and forming at least one of output for welding and output for an alternating current power supply, and is formed by an armature and a field magnet disposed in a housing along an axial direction of a drive shaft, characterized by including

a coreless armature which is fixedly supported in the aforesaid housing and to which an armature coil is mounted, and

a pair of rotating field magnets which have a pair of rotary disks to which permanent magnets are mounted respectively, and are mounted to the aforesaid drive shaft to sandwich the aforesaid armature from both sides in a thickness direction of the armature.

In the present invention, the planar coreless armature is fixed to the housing, and a pair of rotating field magnets by permanent magnets are disposed at both sides in the axial direction, of the armature, and therefore, the generator which is short in the axial length and lightweight can be provided.

### BRIEF DESCRIPTION OF THE DRAWINGS

FIG. 1 is a vertical sectional view showing the constitution of an emobodiment of the present invention;

FIGS. 2A and 2B show structures of an armature and a rotating field magnet in the embodiment shown in FIG. 1, FIG. 2A is a partially vertical sectional view, and FIG. 2B is a side view;

FIG. 3 is an exploded perspective view showing a structure of the embodiment shown in FIG. 1; and

FIG. 4 is an explanatory view showing the flow of cooling air in the embodiment shown in FIG. 1.

### DETAILED DESCRIPTION OF THE INVENTION

An embodiment of the present invention will now be described with reference to the attached drawings.

### Embodiment 1

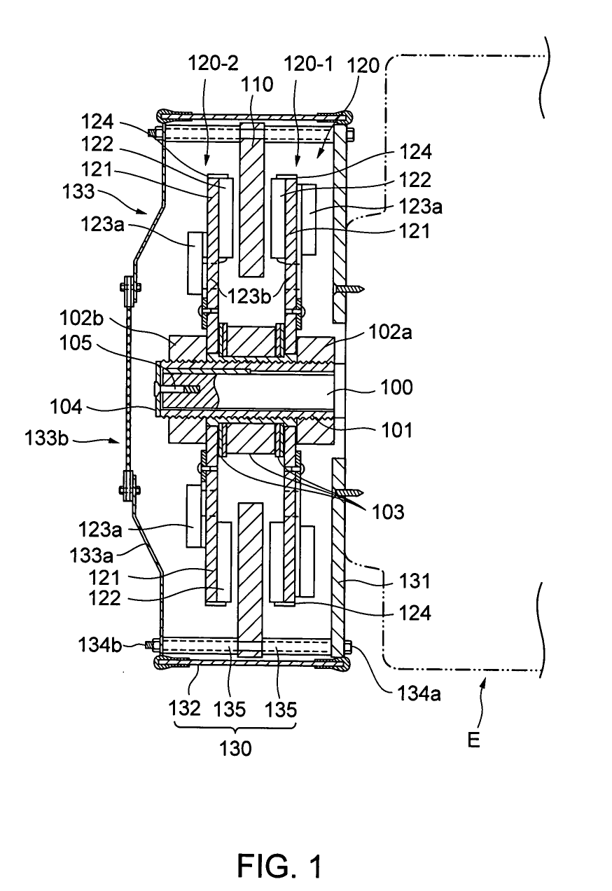

FIG. 1 shows a vertical sectional structure of an emobodiment of the present invention. FIG. 1 shows an engine E that is a drive source at the right side in the drawing (phantom line), and an emobodiment of the present invention is mounted to a drive shaft 100 extended in the left direction in the drawing from the engine E.

Namely, a cylindrical coupling pipe 101 with a key groove is fitted on the drive shaft 100 of the engine E. A pair of field magnets 120-1 and 120-2 disposed to sandwich an armature 110 from both sides in an axial direction are axially positioned and fixed onto a full-flighted outer periphery of the coupling pipe 101 by a pair of large-sized nuts 102a and 102b and a spacer 103.

A key groove of the coupling pipe 101 is positioned with respect to the drive shaft 100 of the engine E, a key is driven into the key groove to perform fixation in the rotational direction, and the coupling pipe 101 is fixed to an end surface of the drive shaft 100 by an end plate 104 and a fastening bolt 105.

The armature 110 is stationary, and is fixed to substantially a center in the axial direction in a housing 130. In a rotating field magnet 120, permanent magnets 122 formed by a rare earth material are bonded to surfaces, which are opposed to the armature 110, of field magnet disks 121 fixed to the coupling pipe 101, and cooling fans 123 are disposed on a rear surface of the field magnet disks 121.

A holding ring 124, which holds an outer peripheral surface of the permanent magnet 122, is fitted on an outer peripheral surface of the field magnet disk 121, and the holding ring 124 holds the permanent magnet 122 against a centrifugal force. The cooling fan 123 is a centrifugal (radial) fan in which blades 123a formed by plate-shaped bent members are mounted to an independent flat disk, and is mounted to an opposite side from the magnet of the field magnet disk.

In order to hold the armature 110 and contain a pair of rotating field 120 inside, a housing 130 constituted of an engine side cover 131, an outer cover 132 with an exhaust port, and an end cover 133 with an intake port is provided. The housing 130 is mounted by the engine side cover 131 being fixed to a casing of the engine E.

Then, the armature 110 is held at a predetermined position on the coupling pipe 101 by a through-bolt 134a, a nut 134b and a collar 135, and an internal space for containing the armature 110 and the rotating field 120 is formed in the housing 130.

This internal space communicates with an outside by the intake port with a wire net provided in a center in the radial direction of the end cover 133, and the outer cover 132 with the exhaust port (not shown), and is constituted so that ventilation for dissipating the heat generated mainly from the armature 110 to the outside by the operation of the cooling fan 123 is performed.

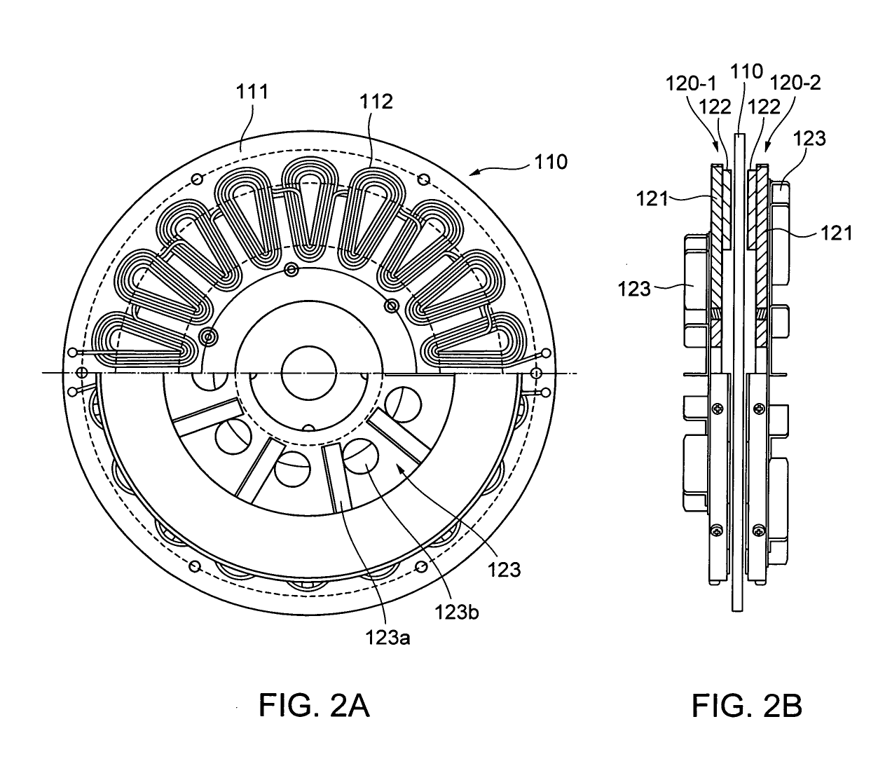

FIGS. 2A and 2B are explanatory views showing the constitution of each of the parts around the armature 110 and the rotating field 120 shown in FIG. 1. FIG. 2B shows the state of the armature 110 and the rotating field 120 seen from the same direction from FIG. 1. As shown in FIG. 2B, the cooling fan 123 is provided at an outer side in the radial direction of the field magnet disk 121 in the rotating field magnet 120-2 at the right side in the drawing, while the cooling fan 123 is provided at an inner side in the radial direction of the field magnet disk 121 in the rotating field magnet 120-1 at the left side in the drawing with the armature 110 therebetween.

Thereby, the cooling fan 123 at the side opposite to the engine changes the flow of the cooling air which the cooling fan 123 takes in from the intake port with the wire net provided at the center of the end cover 133 to the flow toward the outside in the radial direction to take the air inside the housing 130, and the cooling fan 123 at the side of the engine creates a draft which flows toward the outer side in the radial direction in the housing 130 and flows to the outside along the both surfaces of the armature 110.

FIG. 2A shows the state of FIG. 2B seen from the left side direction of FIG. 2B, the upper half of FIG. 2A shows the armature 110, and the lower half of it shows a rear surface of the rotating field 120. FIG. 2A shows a coil constitution of the armature, and 18 coils are disposed in the entire periphery.

In the armature 110 drawn in the upper part of FIG. 2A, nine coreless sector coils 112 formed in a plane shape are disposed in the range of 180 degrees in the surface of a support plate 111 of the armature 110. This is adapted to the fact that the field magnet not shown is constituted of 18 poles. In order to fix the coils 112 to the support plate 111, the coils 112 are molded with the support plate 111 with a resin, for example.

Next, the blades 123a and ventilation holes 123b of the cooling fan 123 are provided on the rear surface of the rotating field 120 drawn in the lower half of FIG. 2A, and ventilation passages to the direction orthogonal to the plane of the rotating field 120 are formed.

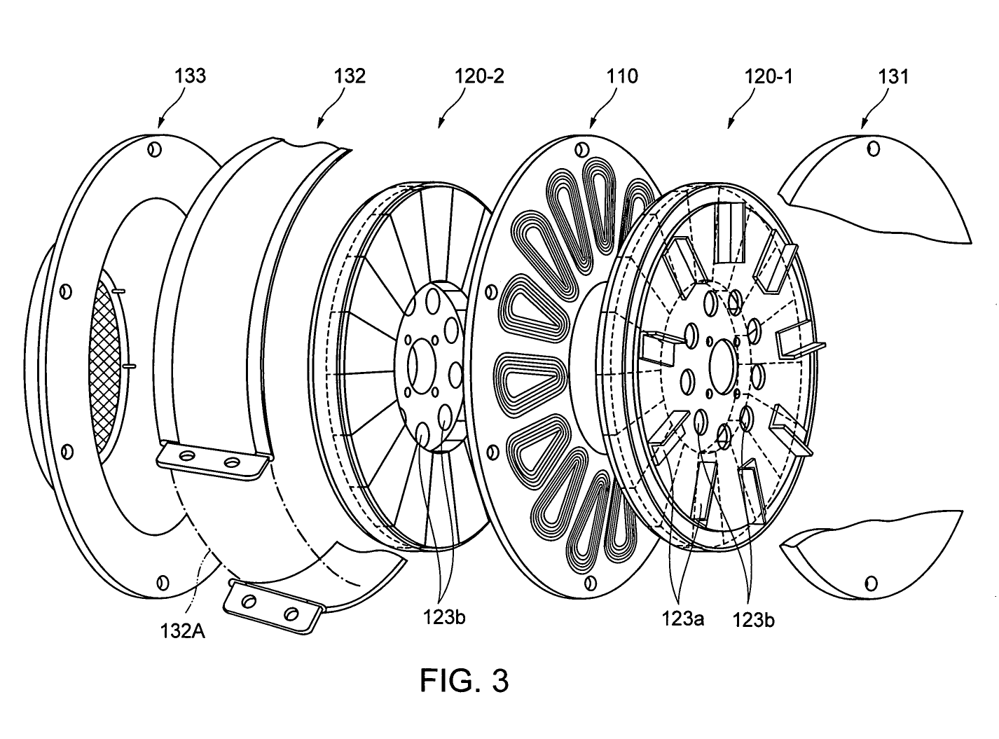

FIG. 3 shows an exploded view of the armature 110 and the rotating field 120 which are main components of the embodiment 1, and the engine side cover 131, the outer cover 132 with the exhaust port and the end cover 133 which constitute the housing 130 that contains these components, and the drive shaft and the components around the drive shaft are omitted in the drawing.

As is understood from the relation in the drawing of the armature and the two rotating field magnets 120-1 and 120-2, the rotating field magnets 120-1 and 120-2 are symmetrically disposed on the drive shaft (not shown) with the armature 110 therebetween, and magnetically, the magnetic fields by the two rotating field magnets 120-1 and 120-2 are similarly caused to act on the armature 110.

Heat generated by the electromagnetic action at the time of this electric generation is released outside from an exhaust port 132A (shown by the phantom line) formed by a part of the outer cover 132 being opened by cooling air as a radial flow which is formed by the cooling fan 123 provided at the rear surface of the rotating field 120. The exhaust port 132A is formed as two openings separated by the armature 110, and is constituted to exhaust heat from both surfaces of the armature 110.

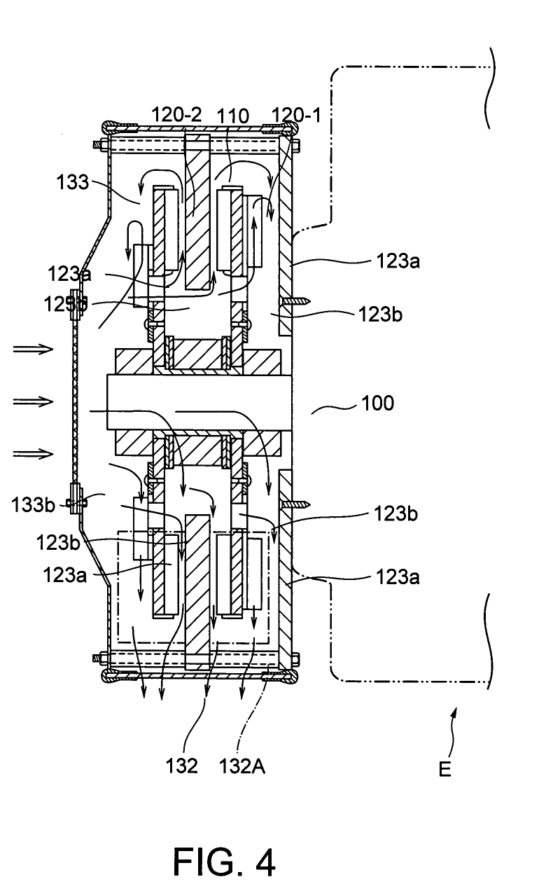

FIG. 4 is a view showing the flow of cooling air inside and outside the housing. As shown by the lines with arrows, the cooling air taken in from the intake port with the wire net provided at the central portion of the end cover 133 first flows toward the end portion of the drive shaft 100, then is changed to the flow outward in the radial direction by the cooling fan 123 at the side opposite to the engine, and becomes the flow in the axial direction through the ventilation holes 123b.

This flow passes along each of the surfaces at the side opposite to the engine and at the side of the engine of the armature 110 and goes outward in the radial direction, and is divided into the flow which deprives both the surfaces of the armature 110 of heat and reaches the exhaust port 132A, and the flow which further passes through the ventilation holes 123b of the rotating field magnet 120-1 at the side of the engine and along the inner wall of the cover 131 at the side of the engine, and goes outward in the radial direction to reach the exhaust port 132A. This flow also cools the surfaces of the two rotating field magnets 120-1 and 120-2 and reaches the exhaust port 132A.

Thereby, the heat generated by the armature 110 and the rotating field magnets 120-1 and 120-2 is effectively discharged outside.

### (Concrete Constitution)

In the above described embodiment, the magnet is explained generally as the permanent magnet, but in concrete, it is suitable to use, for example, a neodymium-iron-boron rare earth magnet in consideration of the temperature-demagnetizing factor characteristics and the like.

As for the constitution of the ventilation passage, especially the exhaust port, the example in which one exhaust port is provided in the outer cover is shown, but the exhaust ports may be provided at a plurality of spots.

Further, in the above described embodiment, the example of the field magnet constituted of 18 poles is shown, but the number of poles with the maximum efficiency is suitably selected in accordance with the number of phases, the rotational frequency and the like of the generator.

What is claimed is:

1. An axial gap type engine driven generator in an axial gap type generator that is an engine driven generator driven by an engine and forming at least one of output for welding and output for an alternating current power supply, and is formed by an armature and a field magnet disposed in a housing along an axial direction of a drive shaft, comprising:
a coreless armature which is fixedly supported in said housing and to which an armature coil is mounted; and
a pair of rotating field magnets which have a pair of rotary disks to which permanent magnets are mounted respectively, and are mounted to said drive shaft to sandwich said armature from both sides in a thickness direction of the armature.

2. The axial gap type engine driven generator according to claim 1,
wherein said coreless armature comprises an armature coil of a planar structure.

3. The axial gap type engine driven generator according to claim 1, further comprising:
a pair of radial fans which are mounted respectively to said pair of rotary disks.

4. The axial gap type engine driven generator according to claim 1,
wherein exhaust ports are provided at outer sides in a radial direction of said radial fans respectively, at both sides in the thickness direction of said coreless armature.

5. The axial gap type engine driven generator according to claim 1, further comprising:
an intake port provided in a center portion in a radial direction of said housing; and
ventilation holes penetrating through said pair of rotating disks and said pair of radial fans.
